(19) United States
(12) Patent Application Publication
(10) Pub. No.: US 2006/0054460 A1
(43) Pub. Date: Mar. 16, 2006

(54) Apparatus for operating a feed device for fiber material, for example, a hopper feeder

(75) Inventor: Bernhard Rubenach, Monchengladbach (DE)

Correspondence Address: VENABLE LLP, P.O. BOX 34385, WASHINGTON, DC, 20045-9998, US

(73) Assignee: TRUTZSCHLER GmbH & CO. KG, Monchengladbach (DE)

(21) Appl. No.: 11/202,168

(22) Filed: Aug. 12, 2005

(30) Foreign Application Priority Data
Aug. 31, 2004 (DE) 10 2004 042 443.8

(51) Int. Cl. B65G 43/00; B65G 37/00; B65G 25/00; B65G 29/00

(52) U.S. Cl. 198/464.4

(57) ABSTRACT

In an apparatus for operating a feed device for fibre material, for example, a hopper feeder, there is provided a drivable, endless conveyor belt guided around two rotatable rolls. The conveyor belt is associated at one end, looking in the conveying direction, with an endless, upwardly inclined spiked lattice. Upstream of the other end of conveyor belt, looking in the opposition direction to the conveying direction, there is arranged an endless feed belt (reserve belt) for receiving fibre bales or the like. To convey fibre material to the hopper feeder in a simple manner, without interruption to production, there is arranged between the conveyor belt and the reserve belt 8a continuously circulating transition belt, and the absence of fibre material on the reserve belt is detectable.

### CROSS REFERENCE TO RELATED APPLICATION

This application claims priority from German Patent Application No. 10 2004 042 443.8 dated Aug. 31, 2004, the entire disclosure of which is incorporate herein by reference.

### BACKGROUND OF THE INVENTION

The invention relates to an apparatus for operating a feed device for fibre material.

In practice, in the manufacture of nonwoven products, hopper feeders are used for opening the bales of raw fibre. In one known form of hopper feeder, a drivable, endless conveyor belt guided around two rotatable rolls is provided. The conveyor belt is associated at one end, looking in the conveying direction, with an endless, upwardly inclined spiked lattice, and upstream of the other end of the conveyor belt, looking opposite to the conveying direction, there is an endless feed belt (reserve belt), on which fibre bales or the like can be placed. The bales of raw fibre supplied to the process are in many cases presented unseparated, in the form of whole bales. To be able to carry out this process with as few reloading operations as possible, long feed belts for holding several bales are required (U.S. Pat. No. 3,939,929). This procedure does reduce the number of reloading operations, but, depending on the batch size, cannot avoid them altogether. The following problem occurs during a reloading operation: so that the mixing chamber is not overfilled, the supply bales are fed from the feed belt in relatively small portions to the mixing chamber. This is achieved owing to the fact that the transport path of the feed belt is adjusted to the desired amount of fibre stripped off. Only when the last portion of raw fibre bale has left the feed belt can the feed belt be fully loaded again. In this case, first of all the raw fibre bales have to be prepared (removal of packaging and bindings), and then placed as close together as possible on the feed belt. This process normally takes up more time than offered by the running reserve in the mixing chamber. The inevitable result is that the hopper feeder will run with no load, which has undesirable effects on the processing process (for example, a variation in the mix or a dip in production).

### SUMMARY OF THE INVENTION

It is an aim of the invention to produce an apparatus of the kind described initially that avoids or mitigates the said disadvantages and in particular in a simple manner enables fibre material to be supplied to the hopper feeder without interruption to production.

The invention provides a feed apparatus for fibre material comprising:
an upwardly inclined feed lattice;
   a first conveyor belt for feeding fibre material to the feed lattice;
   a reserve conveyor belt for receiving fibre bales;
   a transition belt for transporting fibre material from the reserve conveyor belt to the first conveyor belt; and
a device for detecting when the reserve conveyor belt is empty.

The features according to the invention enable the transition belt to be moved independently of the reserve belt. The transition belt can thus deliver fibre material to the conveyor belt so that the mixing chamber does not run without load. At the same time, that is, as the transition belt is running, the reserve belt can be loaded with fibre bales whilst at a standstill. Running with no load is in this manner advantageously reliably avoided, and re-loading of the reserve belt can be effected within an adequate buffer time. By isolating the reserve belt, the belt flight that is feeding fibre to the mixing chamber can be moved independently of the reserve belt. A sensor preferably monitors the end of the belt flight that is feeding fibre material and indicates when the reserve belt has run empty. As the last bale portion present on the belt flight that is feeding fibre material is being worked off in the normal way, the upstream reserve belt can be reloaded independently of the process still under way.

Advantageously, a sensor or the like is used to detect the absence of fibre material. Advantageously, the sensor is an optical barrier, photocell or the like. Advantageously, the sensor is associated with the front end of the reserve belt, looking in the conveying direction. Advantageously, an electronic control and regulating device is provided, to which the sensor and the drive motors for the conveyor belt, the transition belt and the reserve belt are connected. Advantageously, the transition belt is drivable independently of the reserve belt. In particular, it is preferred that the transition belt revolves substantially continuously during operation, and in particular that it continues to revolve when the reserve belt is stationary for reloading. Advantageously, the conveyor belt, the transition belt and the reserve belt are drivable independently of one another. Advantageously, the sensor emits an electronic signal in the absence of fibre material on the feed belt and the drive motor for the reserve belt is stopped. Advantageously, the drive arrangement for the conveyor belt and/or the transition belt is discontinuously controllable. Advantageously, the drive arrangement for the conveyor belt and/or the transition belt can be shut down briefly. Advantageously, the sensor, looking in the conveying direction, is associated with the rear end of the transition belt. Advantageously, the sensor is arranged between the reserve belt and the transition belt. Advantageously, a gap is present between the reserve belt and the transition belt. Advantageously, the front end of the transition belt overlaps the rear end of the conveyor belt from above. Advantageously, the upper belt flights of the reserve belt and the transition belt are arranged substantially at the same level. Advantageously, the drive motor for the spiked lattice is connected to the electronic control and regulating device.

The invention also provides an apparatus for operating a feed device for fibre material, for example, a hopper feeder, in which a drivable, endless conveyor belt guided around two rotatable rolls is provided, which conveyor belt is associated at one end, looking in the conveying direction, with an endless, upwardly inclined spiked lattice and upstream of the other end of which conveyor belt, looking opposite to the conveying direction, there is arranged an endless feed belt (reserve belt), wherein between the conveyor belt and the feed belt (reserve belt) there is arranged a continuously circulating transition belt and the absence of fibre material on the feed belt (reserve belt) is detectable.

### BRIEF DESCRIPTION OF THE DRAWINGS

FIG. 1 is a diagrammatic side view of a hopper feeder with an apparatus according to the invention (transition belt) and fibre material, and

FIG. 2 shows the hopper feeder with the apparatus (transition belt) according to the invention as shown in FIG. 1 with a control and regulating device, to which a sensor as well as drive motors for the spiked lattice, the conveyor belt, the transition belt and the feed belt are connected.

### DETAILED DESCRIPTION OF A PREFERRED EMBODIMENT

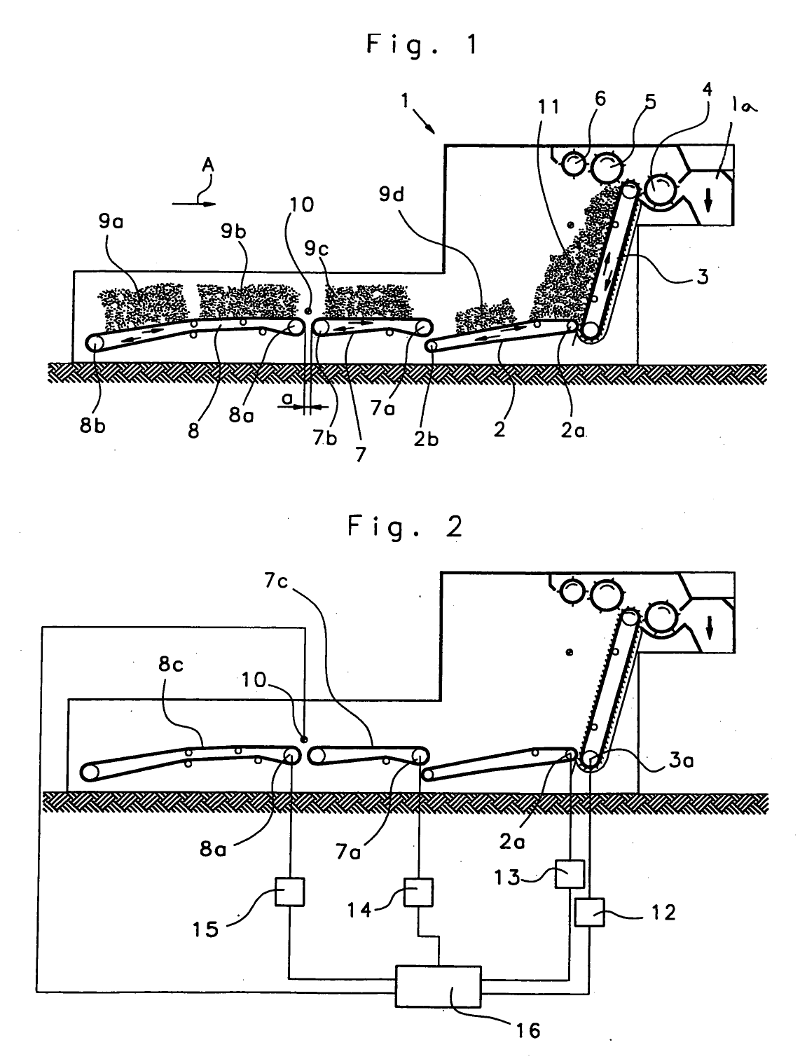

With reference to FIG. 1, a hopper feeder 1 has a conveyor belt 2 (feed apron), spiked lattice 3 (spiked apron), stripping roller 4, evener roller 5 and clearer roller 6. Arranged upstream of the conveyor belt 2, viewed in a direction opposite to the conveying direction A, are a transition belt 7 and a reserve belt 8 (feed belt or feed table). The front guide roller 7a of the transition belt 7 is arranged somewhat above the rear guide roller 2b of the conveyor belt 2, so that the ends of the two belts overlap. The fibre material 9c falls from above onto the conveyor belt 2. The front guide roller 8a of the feed belt 8 and the rear guide roller 7b of the transition belt 7 are arranged relative to one another so that the upper belt flights of the feed belt 8 and the transition belt 7 lie substantially at the same level, thus facilitating transfer of the fibre bales 9b onto the transition belt 7. A narrow gap a is left between the ends of the reserve belt 8 and of the transition belt 7. An optical barrier 10 is present as sensor in the gap a at the level of the fibre bales 9b and 9c. The conveying direction of the belts and belt flights is indicated by arrows. The reference numeral 11 denotes the fibre material in the mixing chamber 1a of the hopper feeder. So that the mixing chamber 1a is not overfilled, the supply bale 9c is fed to the mixing chamber la in relatively small portions 9d. This is brought about by a transport path of the transition belt 7 adjusted to the desired separated amount.

Referring to FIG. 2, the guide roller 3a of the spiked lattice 3 is associated with the variable speed drive motor 12, the guide roller 2a of the conveyor belt 2 is associated with the variable speed drive motor 13, the guide roller 7a of the transition belt 7 is associated with the variable speed drive motor 14 and the guide roller 8a of the reserve belt 8 is associated with the variable speed drive motor 15. The drive motors 12, 13, 14 and 15 and the sensor 10 are in connection with an electronic control and regulating device 16.

Using the apparatus according to the invention, no-load running of the mixing chamber 1a of the hopper feeder 1 is reliably avoided, and within an adequate buffer time the reserve belt 8 is reloaded. Separating the function of the feed belt 8 from the function of the transition belt 7 according to the invention provides an opportunity for the belt portion 7 feeding the mixing chamber 1a to be moved independently of the reserve belt 8. The sensor 10 monitors the end of the portion of belt 7 that is being fed, and signals when the reserve belt 8 has run empty. As the last bale portion 9d present on the belt portion 7 that is feeding fibre is being worked off in the normal way, reloading of the upstream reserve belt 8 can be carried out independently of the process still under way.

Only when the last raw fibre bale portion 9b has left the reserve belt 8 can the reserve belt 8 be completely loaded again. The raw fibre bales first have to be prepared (removal of packaging and bindings) and then placed as closely together as possible on the feed belt 8.

The function of the conveyor belt 2 is to feed the fibre material to the spiked lattice 3. The function of the reserve belt 8 is to make available a supply of material in the form of bale layers or whole bales 9a, 9b. The function of the transition belt 7 is twofold: it feeds fibre material 9c to the conveyor belt 2 and holds a supply of fibre material 9c ready even when the empty reserve belt 8 is being loaded with new fibre bales 9, 9b while at a standstill.

Although the foregoing invention has been described in detail by way of illustration and example for purposes of understanding, it will be obvious that changes and modifications may be practised within the scope of the appended claims.

1. A feed apparatus for fibre material comprising:
an upwardly inclined feed lattice;
a first conveyor belt for feeding fibre material to the feed lattice;
a reserve conveyor belt for receiving fibre bales;
a transition belt for transporting fibre material from the reserve conveyor belt to the first conveyor belt; and
a device for detecting when the reserve conveyor belt is empty.

2. An apparatus according to claim 1, in which the device for detecting the absence of fibre material is a sensor.

3. An apparatus according to claim 2, in which the sensor is an optical barrier or photocell.

4. An apparatus according to claim 1, in which the sensor is associated with the front end of the reserve belt.

5. An apparatus according to claim 2, in which the sensor is associated with the rear end of the transition belt.

6. An apparatus according to claim 2, in which the sensor is arranged between the reserve belt and the transition belt.

7. An apparatus according to claim 1, in which a gap is present between the reserve belt and the transition belt.

8. An apparatus according to claim 1, in which the front end of the transition belt overlaps the rear end of the first conveyor belt from above.

9. An apparatus according to claim 1, in which the upper belt flights of the reserve belt and the transition belt are arranged substantially at the same level.

10. An apparatus according to claim 1, in which there is provided an electronic control and regulating device, to which the detecting device and the drive motors for the conveyor belt, the transition belt and the reserve belt are connected.

11. An apparatus according to claim 10, in which the first conveyor belt, the transition belt and the reserve belt are drivable independently of one another.

12. An apparatus according to claim 10, in which the sensor emits an electronic signal in the absence of fibre material on the reserve belt and the drive motor for the reserve belt is stopped.

13. An apparatus according to claim 10, in which the drive arrangement for the first conveyor belt and/or the drive arrangement for the transition belt is discontinuously controllable.

14. An apparatus according to claim 10, in which the drive arrangement for the first conveyor belt and/or the drive arrangement for the transition belt can be shut down briefly.

15. An apparatus according to claim 10, in which the drive motor for the spiked lattice is connected to the electronic control and regulating device.

16. A hopper feeder for fibre material, comprising:
an upwardly inclined feed lattice;
a first conveyor belt for feeding fibre material to the feed lattice;
a reserve conveyor belt for receiving fibre bales;
a transition belt for transporting fibre material from the reserve conveyor belt to the first conveyor belt; and
a sensor device for detecting when a supply of textile bales on the reserve conveyor is exhausted;
the transition belt being so arranged that it can continue to revolve when the reserve conveyor belt is stationary.

17. An apparatus according to claim 4, in which the sensor is associated with the front end of the reserve belt.

18. An apparatus according to claim 12, in which the sensor emits an electronic signal in the absence of fibre material on the reserve belt and the drive motor for the reserve belt is stopped.
